(19) United States
(12) Patent Application Publication
(10) Pub. No.: US 2009/0293739 A1
(43) Pub. Date: Dec. 3, 2009

(54) Grill Device

(76) Inventor: Jerome Poiret, Villeneuve Loubet (FR)

Correspondence Address: Stephen B. Ackerman, 28 Davis avenue, Poughkeepsie, NY, 12603, US

(21) Appl. No.: 12/226,784

(22) PCT Filed: Mar. 16, 2007
(86) PCT No.: PCT/EP2007/002361

§ 371 Date: Mar. 9, 2009

(30) Foreign Application Priority Data
Apr. 28, 2006 (EP) 06368009.4

(51) Int. Cl. A47J 37/06

(52) U.S. Cl. 99/450

(57) ABSTRACT

Cooking device of the grill type comprising a frame fitted with two lateral sliders and a grill structure comprising a first and a second grill articulated relative to each other in such a way as to constitute a cooking compartment. The grill structure comprises two lateral bars or plates each fitted with:
a tenon intended to slide into one of the two sliders;
an articulation point receiving the end of an arm that is able to rotate around a fixed pivot located at one end of the slider. Therefore, the grills become easily reversible in relation to the frame which has only to be placed over the live charcoal in order to obtain cooking of the food. Live charcoal or any other heating element: gas, electric broiler, lava stones, infrared, heating body, etc.

### TECHNICAL FIELD OF THE INVENTION

This invention relates to the domain of cooking units and in particular to a grill device, fixed or movable.

### PRIOR ART

A large number of grill devices are known making it possible to carry out the cooking of food in a natural and pleasant manner, which are commonly referred to as barbecue.

The known devices have the disadvantage of awkward manipulation of the food to cook and in particular when it must be turned over on the cooking surface. It is not uncommon for the diner which is operating the grill to receive a burn or to partially ruin the food to cook.

This invention has for purpose to overcome these disadvantages.

### DESCRIPTION OF THE INVENTION

This invention has for purpose to propose a cooking device of the grill type that is easy to realise and that makes it possible to easily manipulate the food to cook.

Another purpose of this invention consists in proposing a cooking device that can be adapted easily to any existing barbecue.

The invention realises these purposes by means of a cooking device of the grill type comprising a frame fitted with two lateral sliders and a grill structure comprising a first and a second grill articulated relative to each other in such a way as to constitute a cooking compartment. The grill structure comprises two lateral bars or plates each fitted with:
a tenon intended to slide into one of the two sliders;
an articulation point receiving the end of an arm that is able to rotate around a fixed pivot located at one end of the slider. Therefore, the grills become easily reversible in relation to the frame which has only to be placed over the live charcoal to obtain the cooking of the food. Live charcoal or any other heating element: gas, electric broiler, lava stones, infrared, heating body, etc.

In a particular embodiment, the first and second grills are articulated by means of a chain link, a ring or a hinge.

More preferably, the grill structure is fitted with a closing mechanism for the first and second grills avoiding the falling of food on the cooking surface when manipulating the grills.

In an embodiment the frame comprises adjustable feet and is removable in relation to the heating body making it possible to cook the food.

In a specific embodiment, the frame is fitted with fastening elements to a pre-existing barbecue structure.

### DESCRIPTION OF THE DRAWINGS

Other characteristics, purposes and advantages of the invention shall appear when reading the description and the drawings hereinafter, provided solely by way of non-limiting examples. In the annexed drawings:

FIG. 1 shows a grill structure in accordance with this invention.

FIG. 2 shows the structure of FIG. 1, cooperating with a frame 100 providing the function of reversibility of the grill.

FIGS. 3 and 4 show a removable embodiment of the frame 100.

FIG. 5 shows an example of an embodiment of a heating body adapted to receive the frame 100.

FIG. 6 shows a dual structure of the frame 100 intended to receive two sets of grills 1, 2 and 1′, 2′.

FIG. 7 shows an embodiment of the slider 13 making it possible to block the grill.

FIG. 8 shows an adjustable structure of the frame 100.

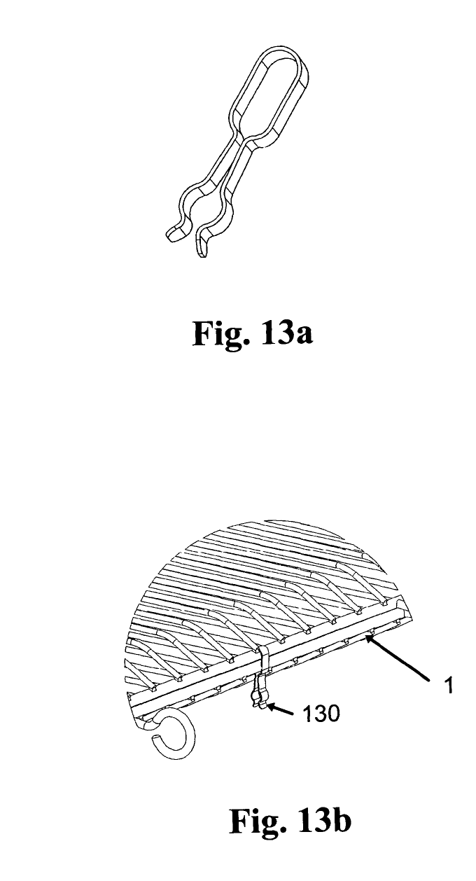

FIGS. 9, 10, 11 and 12 show two other profiles that can be considered to realise the slider 13, i.e. as “S”, “U” and as “H”.

FIGS. 13a to 13d show a particular embodiment of the device according to the invention fitted with a closing clip.

FIGS. 14a and 14b show an opening hook that is specially adapted to the device according to the invention.

FIGS. 15a to 15d show a particular embodiment of the device according to the invention comprising a maintaining blade of the food to cook.

FIGS. 16a to 16d show a particular embodiment of the device according to the invention comprising a snap-fit cooking plate on the grill.

FIGS. 17a and 17b shows the device according to the invention fitted with its closing rings and their manipulation by means of an opening hook in FIGS. 14a and 14b.

FIGS. 18a and 18b show a particular embodiment of the device according to the invention comprising two dual structures of grills that can be manipulated independently.

FIGS. 19a and 19b show a particular embodiment of the device according to the invention in a “table” or “table top” version.

FIGS. 20a and 20b show a particular mode of the turning mechanism of the grill in its “table” version.

### DESCRIPTION OF A PREFERRED EMBODIMENT

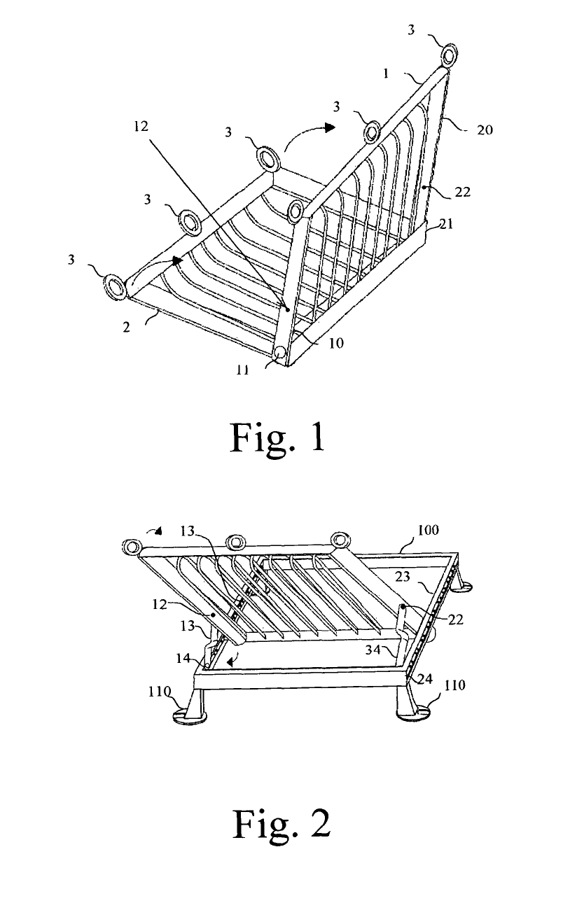

FIG. 1 shows a cooking device in accordance with this invention, which is comprised of a first cooking grill 1 having two lateral plates or bars 10 and 20 intended to form a rigid structure.

Other than the first grill 1, the element comprises a second cooking grill 2 articulated in relation to the first in such a way as to delimit, once in “closed” position a cooking compartment for the food to be cooked. Note that the articulation of the two grills 1 and 2 can be realised in multiple ways, for example by means of a hinge, chain links, rings etc. FIG. 1 shows more particularly the cooking structure, in half-open position.

A closing system of the two grills 1 and 2 can be provided—for example by means of rings making it possible to provide satisfactory blocking of the two grills and avoid the falling of food onto the live charcoal during the manipulation of the cooking structure. Those skilled in the art can clearly adapt any other closing and blocking system.

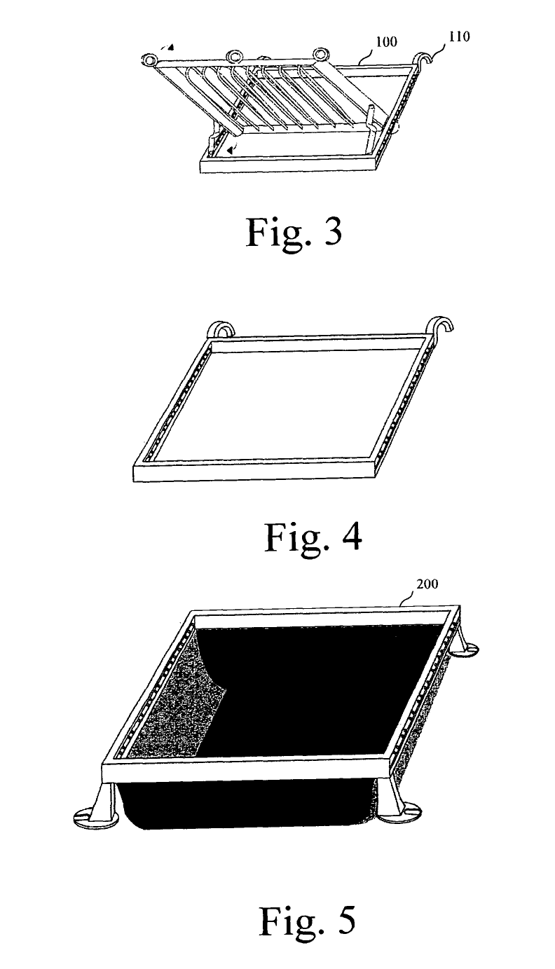

Each of the two lateral bars or plates 10 and 20 comprises a tenon 11 (resp. 21) as well as an articulation point 12 (resp. 22). The tenon 11 (resp. 21) is intended to slide into a slider 13 (resp. 23) of a rigid frame 100 shown in FIG. 2 in such a way as to guide the structure comprised by the two grills 1 and 2 and maintain the ends of the bars 10 and 20 in the plane of the rigid frame 100.

The articulation point 12 (resp. 22) is intended to receive the end of an arm 13 (resp. 23) which can also rotate via its other end around a fixed pivot 14 (resp. 24) located at one end of the slider 13 (resp. 23).

It is observed that when grill structure in FIG. 1 is turned over, the articulation points 12 and 22 remain in the same circumference in relation to the fixed pivots 14 and 24 and, what is more, the ends of the bars or plates 10 and 20 remain in the plane defined by the sliders 13 and 23.

It is observed as such that a perfect guiding of the grill structure is provided, formed by the two elements 1 and 2, when it is turned in relation to the frame in FIG. 2.

In a particular embodiment, the frame is fixed on four legs—adjustable or non-adjustable, in such a way as to provide an appropriate distance in relation to the live charcoal cooking surface. Live charcoal or any other heating element: gas, electric broiler, lava stones, infrared, heating body, etc.

It is observed that this is a cooking appliance that is easy to maneuver, without the risk of burns for the user, and which avoids the falling of food onto the live charcoal.

The rigid frame 100 comprising the two sliders 13 and 23 can take on the form of highly diverse realisations.

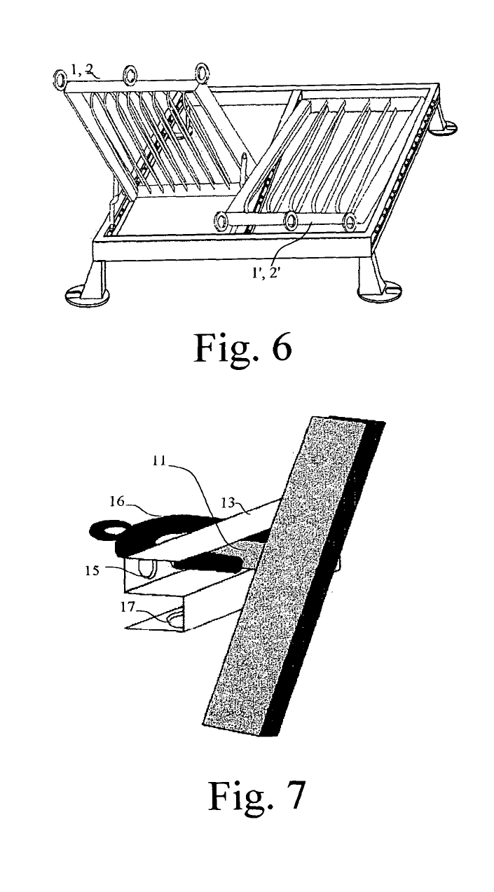

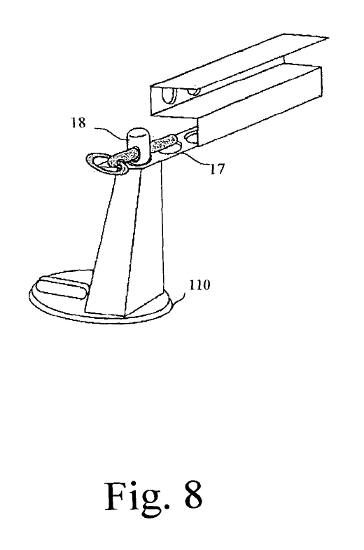

In a first embodiment, shown in FIG. 3, the rigid frame 100 can be designed in an easily-removable manner in relation to cooking surface body 200 shown in FIG. 5. FIG. 4 shows an embodiment wherein the reversible cooking structure formed by the two grills 1 and 2 can be removed easily, in such a way as to facilitate the cleaning of the unit.

Those skilled in the art can even adapt the rigid frame 100 in such a way as to allow for placing it on a pre-existing barbecue or grill structure. The invention then takes the form of a grill “kit” comprised of a reversible grill structure in a frame 100 that can be removed easily.

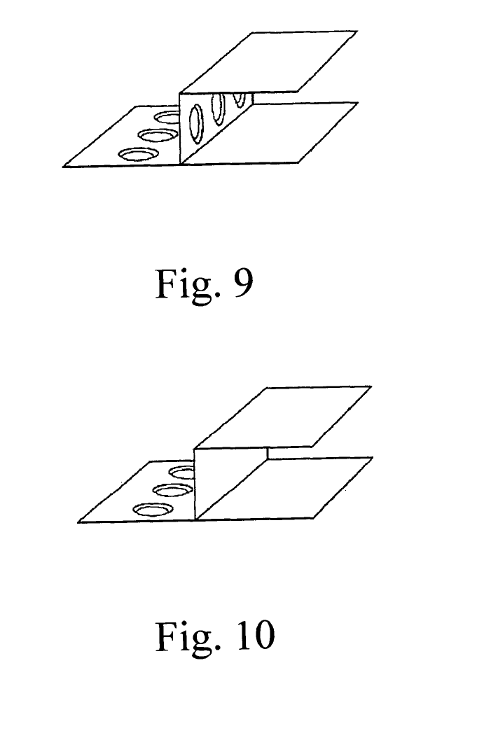

FIG. 6 shows an alternative execution of this invention, comprising two grill structures 1, 2 and 1′, 2′ that are similar to the structure described previously in reference to FIG. 1. The two structures are reversible independently in relation to one another.

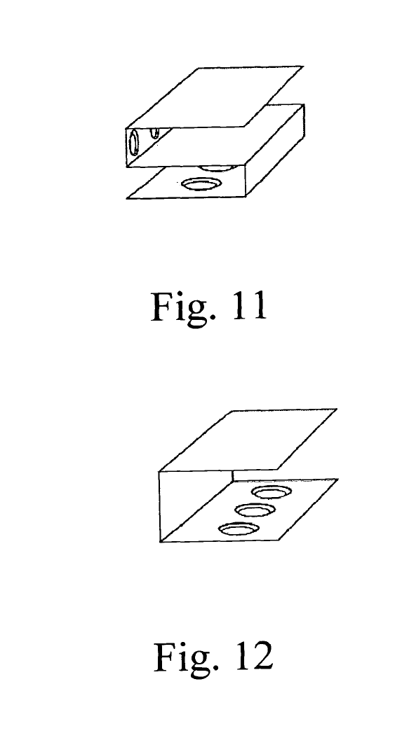

FIG. 7 shows a specific embodiment of the invention wherein a series of orifices 15 is provided on the bottom of the slider 13 intended to receive a blocking key 16, having the form of a “U” of which each end can be engaged in one of the orifices 15 and block the longitudinal displacement of the tenon 11 and, consequently, the maintaining of the grill in a predetermined position.

As can be seen in the diagram in FIG. 7, the slider 13 of the rigid frame can have a profile as “S” making it possible to have a second series of orifice 17 allowing for an adjustable fastening, of the legs 110 by means of an end piece 18 intended to nest into one of the orifices 17.

The cooking appliance consequently becomes perfectly removable and, advantageously, can be adapted easily to any pre-existing structure.

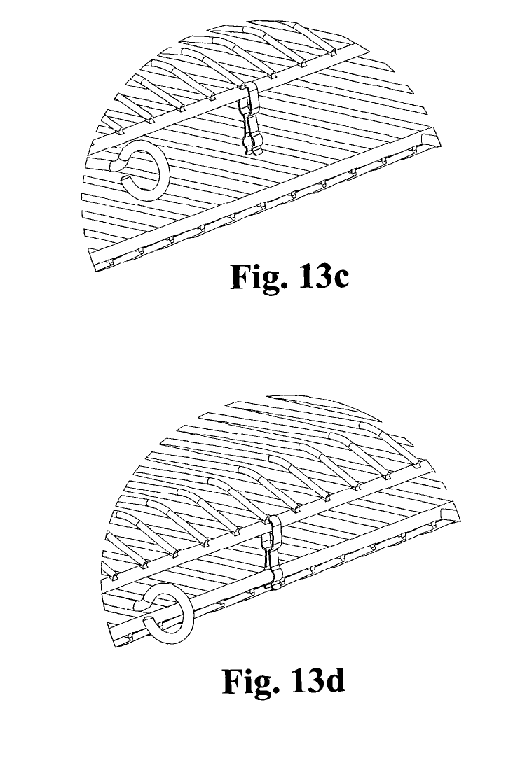

FIGS. 9, 10, 11 and 12 show two other profiles that can be considered to realise the slider 13, i.e. as “S”, “U” and as “H”.

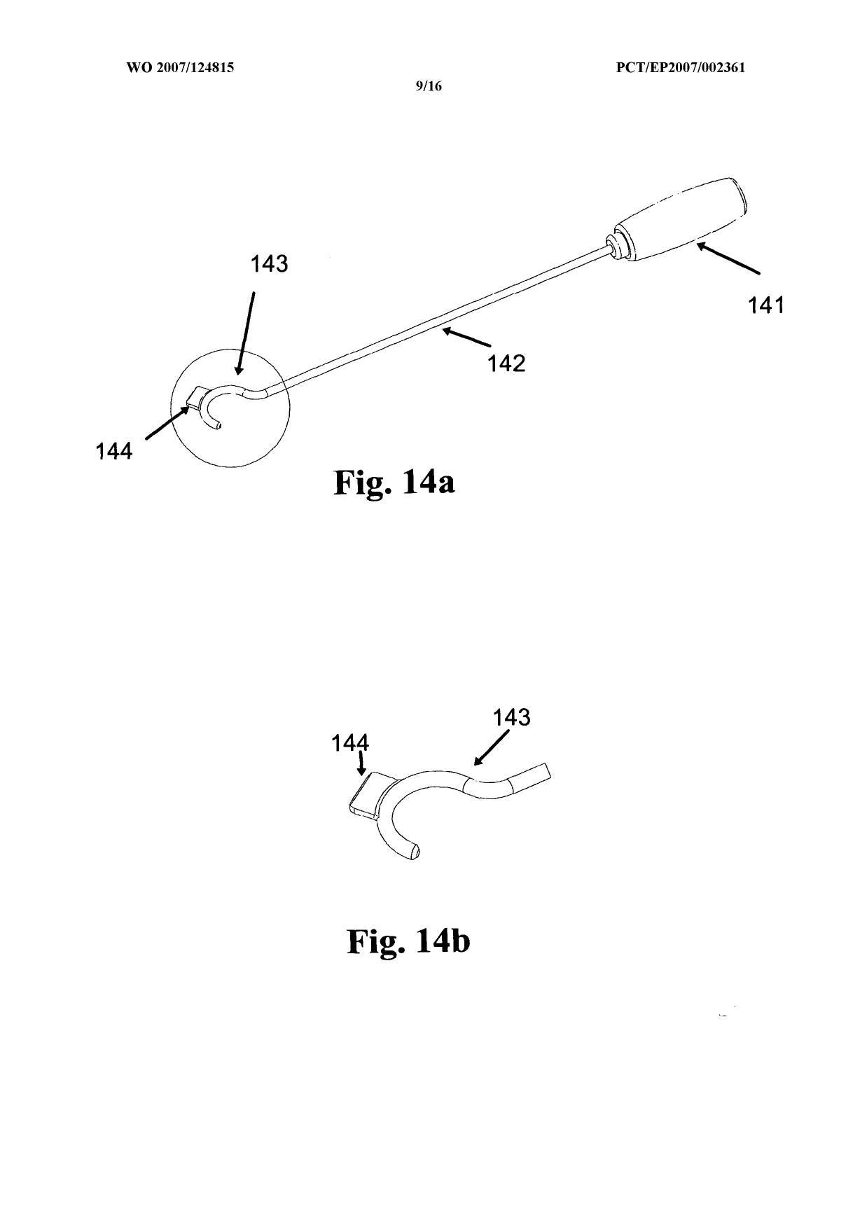

FIG. 13a shows a closing clip making it possible to easily fasten the two grills 1 and 2. More preferably the clip shall have a form making possible a double level of blocking so as to allow for the cooking of two pieces of food of separate thicknesses.

FIG. 13b shows such a clip 130 once fixed on the grill 1, and FIGS. 13c and 13d show the clip in the situation before and after the blocking.

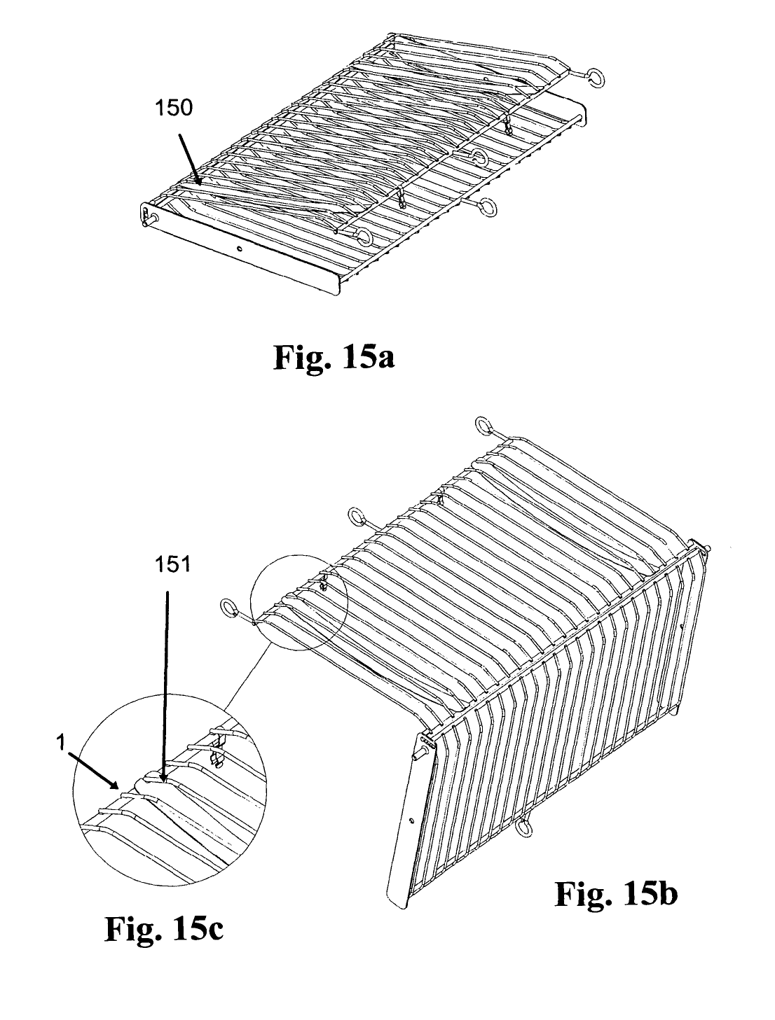

FIGS. 14a and 14b show a special tool designed for the device according to the invention comprising a handle 141, a rod 142 and a hook 144 that is specially adapted to engage in the closing rings of each of the grills 1 and 2. In a particular embodiment, the hook of the tool is fitted with a plate intended to allow for easy “unsnapping” of the two grills 1 and 2 when the cooking is complete.

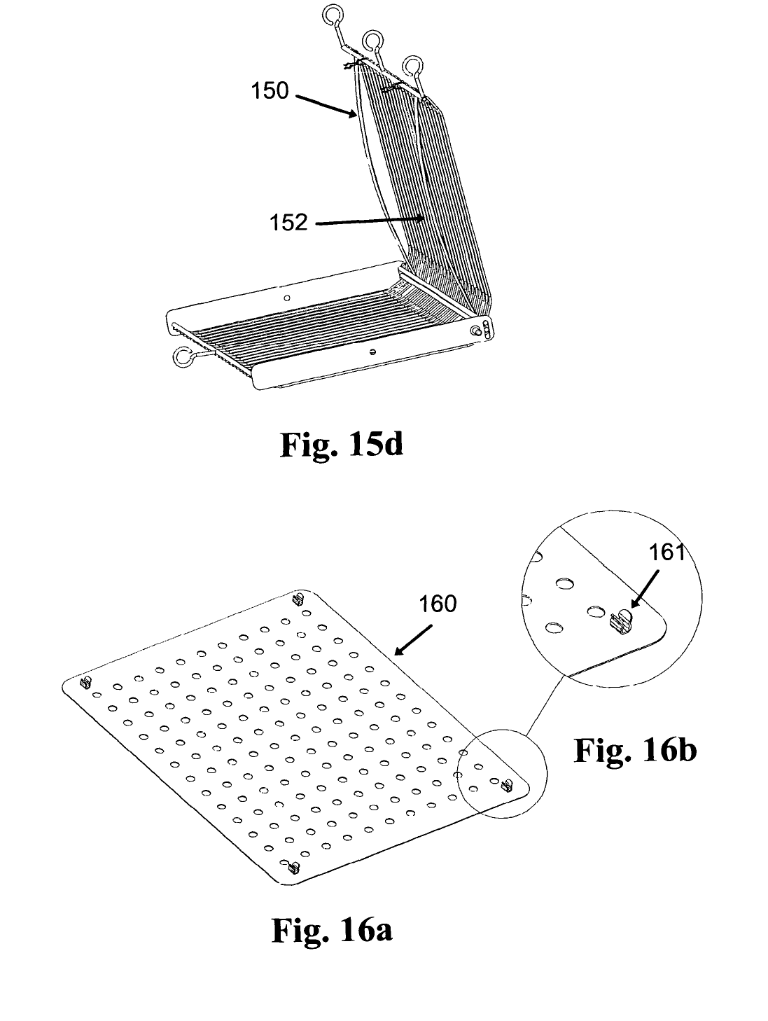

FIGS. 15a and 15b show another specific embodiment of the device comprising a spring plate 150, of a length that is slightly longer than the depth of a grill and having two grooved ends allowing it to be fixed on the grill. Once the plate 150 is fixed on one of the grills 1 or 2, and the two grills locked via the clip 130, an effective maintaining of the food to be cooked is obtained by means of this plate.

FIG. 15c shows the detail of the fastening of the end 151 of the plate 150 on the grill 1 and FIG. 15d shows an embodiment comprising two separate spring plates 150 and 152.

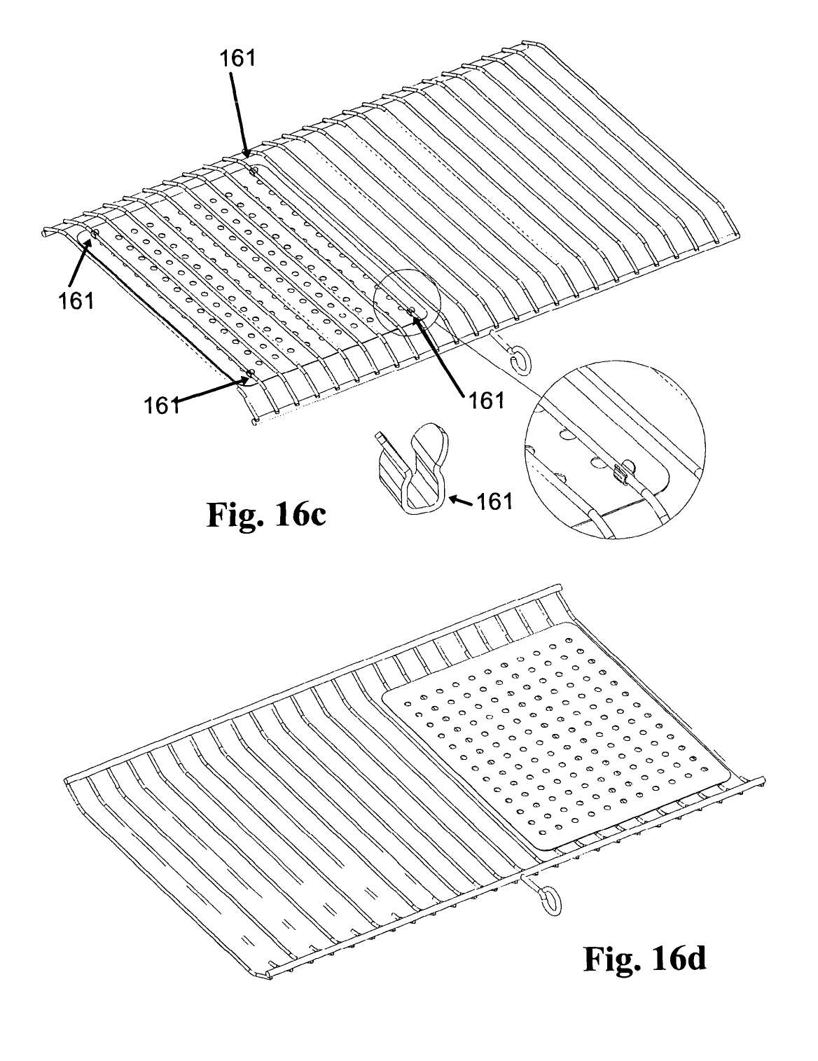

FIGS. 16a and 16b show another embodiment of a device according to the invention comprising, on one of the grills, a cooking plate 160 fitted with orifice 1 and itself snapable on one of the grills by means of fastening clips 161.

FIG. 16c shows the fastening of the plate on the grill by means of four identical fastening clips 161.

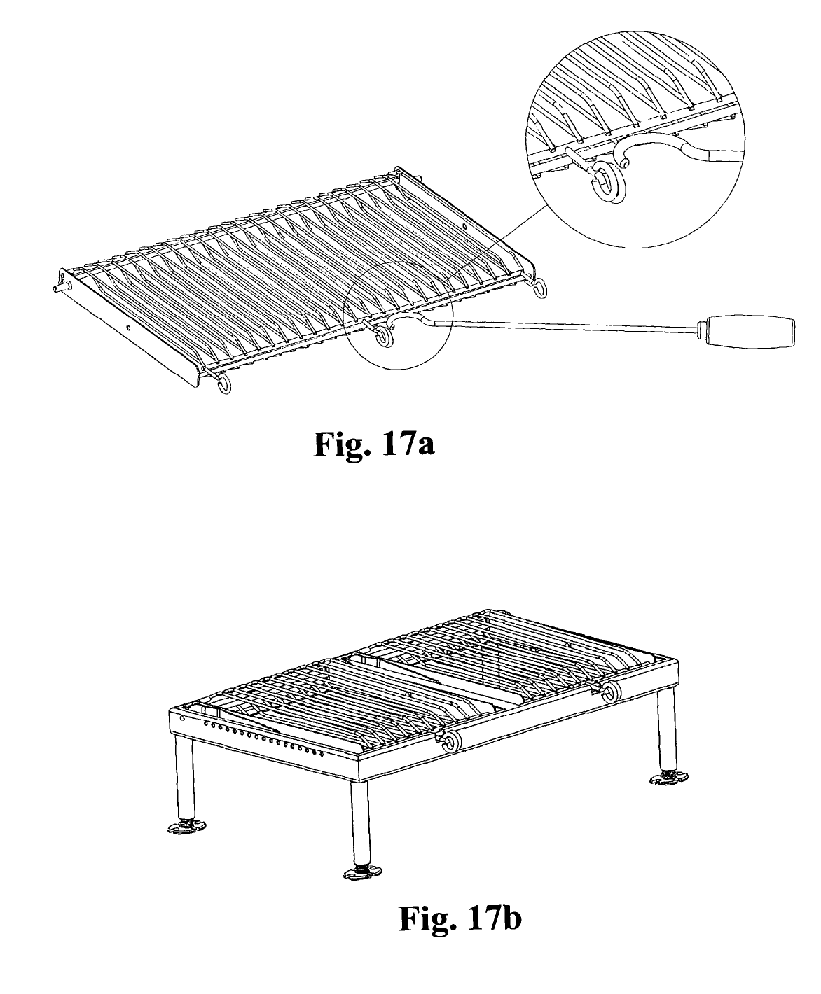

FIGS. 17a and 17b show the device according to the invention fitted with its closing rings and their manipulation by means of the opening hook in FIGS. 14a and 14b.

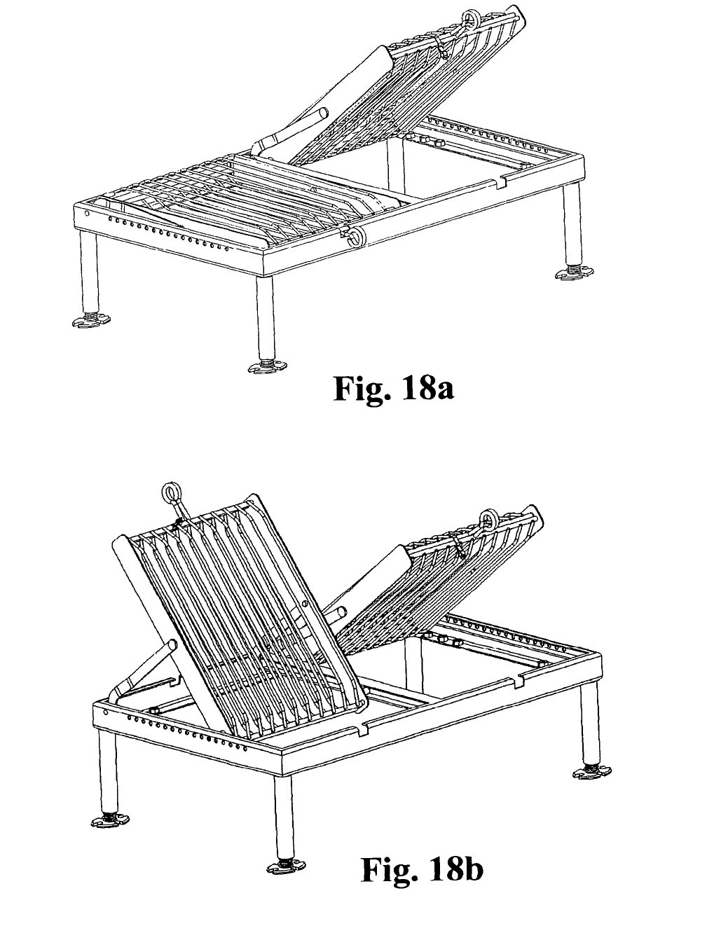

FIGS. 18a and 18b show a particular embodiment of the device according to the invention comprising two dual structures of grills that can be manipulated independently in relation to one another. In a specific embodiment, the legs of the structure shall be replaced with a clip allowing for the fastening of the device on the pre-existing grill of a barbecue.

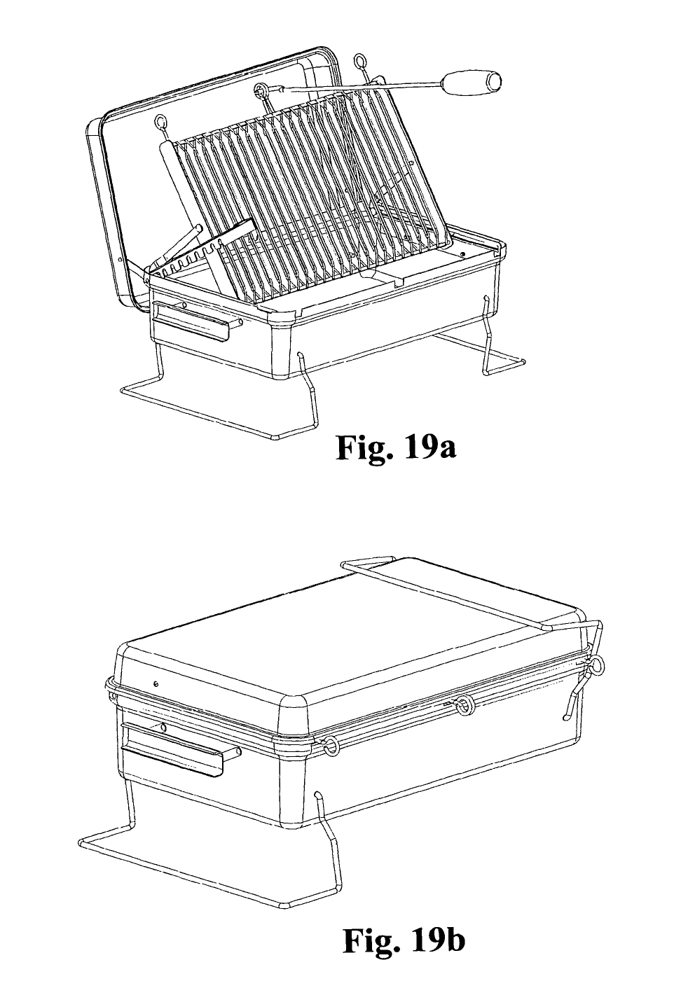

FIGS. 19a and 19b show a particular embodiment of the device according to the invention in “table” or “table top” version.

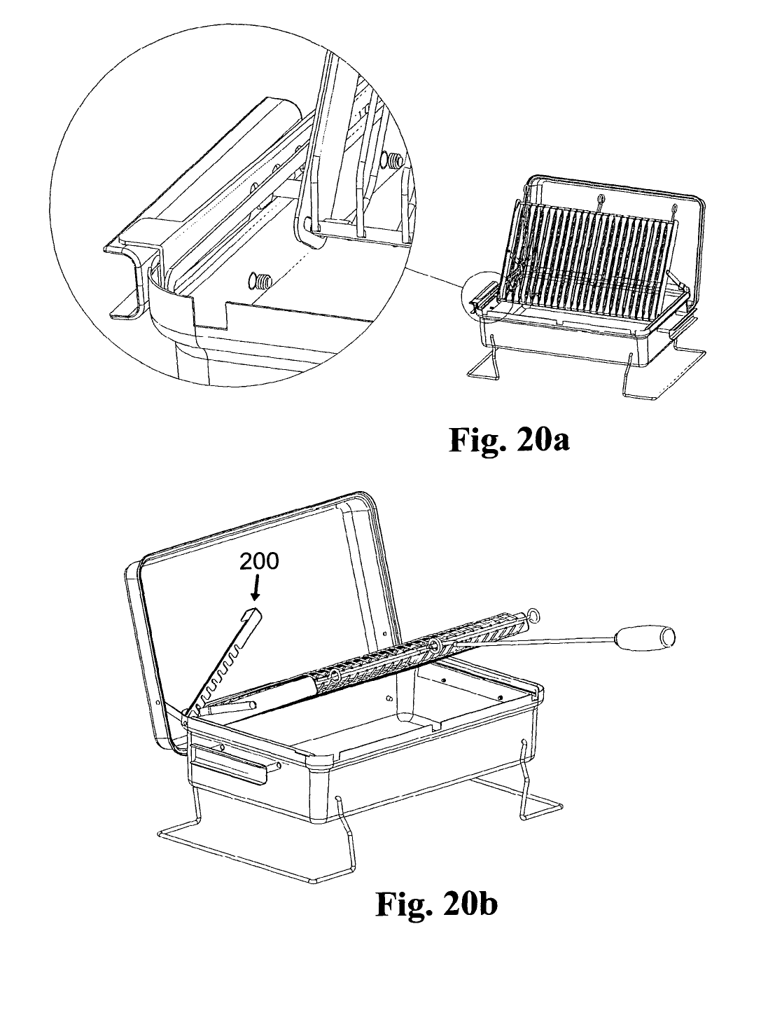

FIGS. 20a and 20b show a particular mode of the device according to the invention comprising a support bar (200) articulated at one end of the slider (13, 23) and fitted with teeth in such a way as to block the displacement of the tenon (11, 21) and immobilise the grills (1, 2) in a predetermined position.

1. A cooking device of the grill type comprising:
a frame comprising two lateral sliders; and
a first grill structure comprising a first and a second grill articulated relative to each other in such a way as to comprise a cooking compartment, said structure comprising two lateral bars or plates each comprising:
a tenon intended to slide into one of said two sliders; and
an articulation point receiving the end of an arm that is able to rotate around a fixed pivot located at one end of said slider.

2. The cooking device according to claim 1 wherein said first and second grills are articulated by means of a chain link, a ring or a hinge.

3. The cooking device according to claim 1 further comprising a closing system for said first and second grills.

4. The cooking device according to claim 1 wherein said frame is fitted with height-adjustable feet.

5. The cooking device according to claim 1 wherein said frame is removable in relation to a body receiving said cooking device.

6. The cooking device according to claim 1 further comprising means for fastening said frame to a pre-existing barbecue or grill structure.

7. The cooking device according to claim 1 further comprising a second grill structure identical to said first grill structures wherein said first and second grill structures are reversible independently in relation to one another.

8. The cooking device according to claim 1 further comprising a first series of orifices on the bottom of one of said sliders intended to receive a blocking key making it possible to block the longitudinal displacement of said tenon.

9. The cooking device according to claim 8 wherein at least one of said sliders has a profile in the shape of an “S” comprising a second series of orifices allowing for an adjustable fastening of said frame.

10. The cooking device according to claim 1 wherein one of said sliders has a profile in the shape of an “S”, “U” or “H”.

11. The cooking device according to claim 1 wherein each of said first and second grills comprises a ring allowing it to be manipulated by means of a tool comprising a handle, a rod, and a manipulation hook.

12. The cooking device according to claim 1 wherein each of said first and second grills comprises a spring plate comprising two grooves at its ends wherein said spring plate is able to be fixed on any of said first and second grills in such a way as to provide for the maintaining in place of the food to be cooked.

13. The cooking device according to claim 1 further comprising a cooking plate that can be snapped onto to any of said first and second grills.

14. The cooking device according to claim 1 further comprising a support bar articulated at one end of the slider and fitted with teeth in such a way as to be able to block the displacement of said tenon and immobilize said first and second grills in a predetermined position.

15. A cooking device of the grill type comprising:
a frame comprising two lateral sliders;
a first grill structure comprising a first and a second grill articulated relative to each other in such a way as to comprise a cooking compartment, said structure comprising two lateral bars or plates each comprising:
a tenon intended to slide into one of said two sliders; and
an articulation point receiving the end of an arm that is able to rotate around a fixed pivot located at one end of said slider; and
a means for fastening said frame to a pre-existing barbecue or grill structure.

16. The cooking device according to claim 15 wherein said first and second grills are articulated by means of a chain link, a ring or a hinge.

17. The cooking device according to claim 15 further comprising a closing system for said first and second grills.

18. The cooking device according to claim 15 further comprising a second grill structure identical to said first grill structure wherein said first and second grill structures are reversible independently in relation to one another.

19. The cooking device according to claim 15 further comprising a first series of orifices on the bottom of one of said sliders intended to receive a blocking key making it possible to block the longitudinal displacement of said tenon.

20. The cooking device according to claim 19 wherein at least one of said sliders has a profile in the shape of an “S”, “U”, or “H” comprising a second series of orifices allowing for an adjustable fastening of said frame to said pre-existing barbecue or grill structure.
